(19) United States
(12) Patent Application Publication
(10) Pub. No.: US 2004/0052298 A1
(43) Pub. Date: Mar. 18, 2004

(54) Thermometer lens cover

(76) Inventor: Craig Michael Kompa, Beckley, WV (US)

Correspondence Address: CRAIG MICHAEL KOMPA, 402 E ST., BECKLEY, WV, 25801, US

(21) Appl. No.: 10/241,849

(22) Filed: Sep. 13, 2002

(51) Int. Cl. G01K 1/08

(52) U.S. Cl. 374/158

(57) ABSTRACT

An assortment of thermometers lens covers is described wherein the sizes or dimensions are undefined. The lens covers may be assembled or attached irrelevant of the dimensions or size to any analog thermometer, whether the shape being round or geometric. The plano-convex thermometer lens cover will magnify, enlarging the numbers and the calibration indicators of the thermometer. The result of the magnifying lens cover is to increase visibility at a distance.

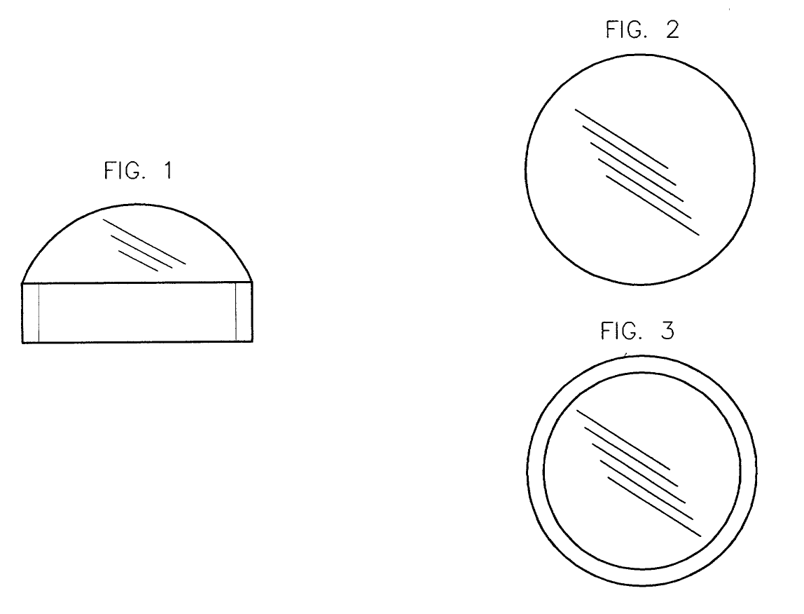

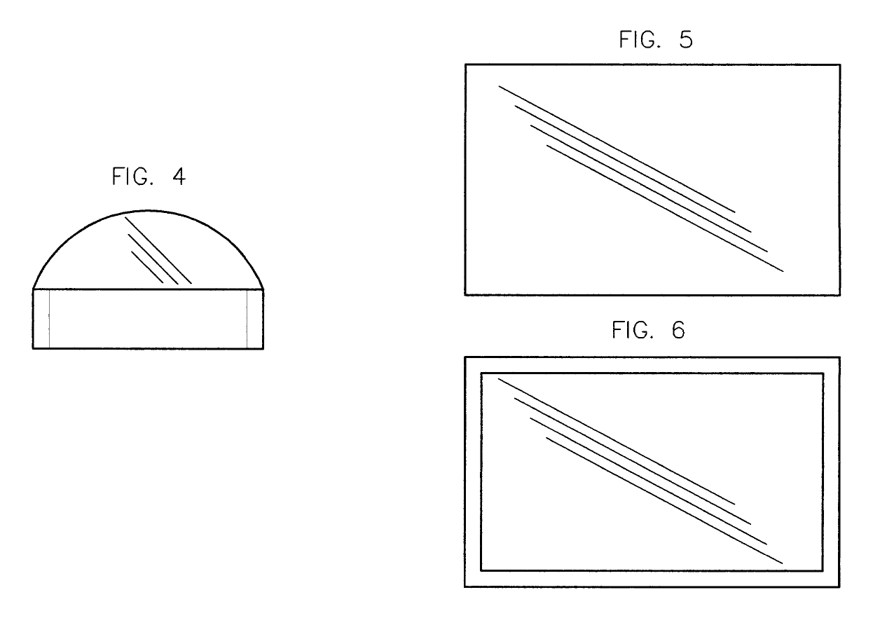

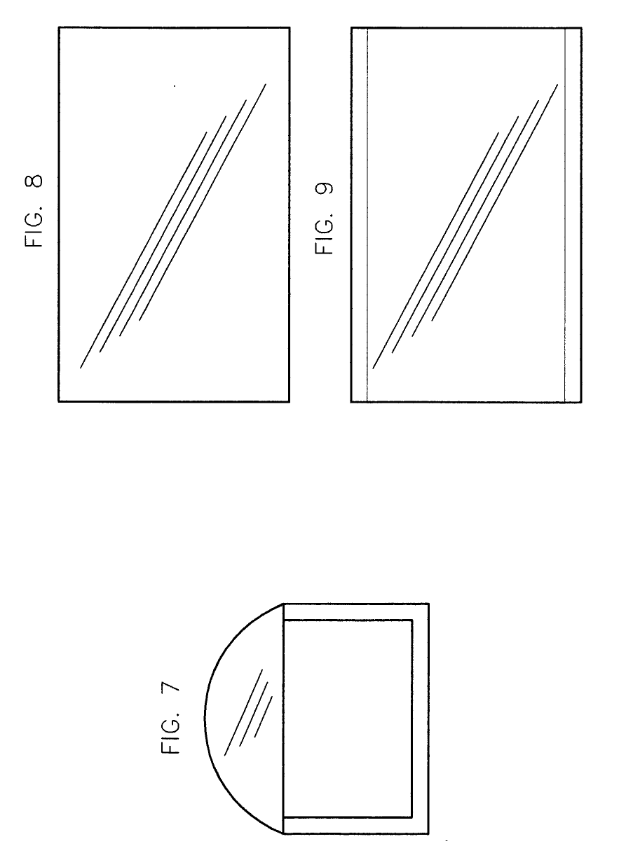

### RELATED APPLICATIONS

This application is referenced to application Ser. No. 29/128,132, filed on Aug. 2, 2000, patented on Sep. 18, 2001, U.S. Pat. No. US D447,964 S.

I Craig M. Kompa a citizen of the United States and resident of Beckley, W.Va. have invented a new thermometer lens cover, of which the following is a specification. The lens cover is designed to magnify any analog thermometer, round or geometric irrelevant of the shape of the thermometer.

### STATEMENT REGARDING FEDERALLY SPONSORED RESEARCH OR DEVELOPEMENT

NOT APPLICABLE

### REFERENCED TO MICROFICHE APPENDIX:NOT APPLICAABLE BACK GROUND OR TECHNICAL FIELD OF THE INVENTION

My invention, the thermometer lens cover originated from physics in the specification of optics. The most basic lens is a double plano-convex lens (E.G., a magnifying lens held hand); to the lens inside any binocular or monocular. An example of a monocular is a telescope. The double-convex lens which exists in any telescope is halved resulting in a plano-convex lens.

### BRIEF SUMMARY OF THE INVENTION

The plano-convex thermometer lens cover will magnify enabling one to view the numbers and thermometer easier.

### VIEWS OF DRAWING

Figure one is side view if round. Figure two is top view if round, Figure three is bottom view if round. Figure four is front or end view if geometric (I.E., square or rectangular). Figure five is top view if geometric. Figure six is bottom view if geometric. Figure seven is front or end view if geometric. Figure eight is top view if geometric. Figure nine is the bottom view if geometric.

### DETAILED DESCRIPTION OF THE INVENTION

The plano-convex thermometer lens cover should me made of custom injection molded synthetic polymer or plastic. The polymer has to be translucent and transparent. Figure one is a round lens, bottom open; this lens can be assembled or attached by placing the lens on a round shaped analog thermometer. Figure four is a geometric shaped lens, bottom open endsclosed and can assembled or attached by placing thelens on a geometric shaped thermometer, this is relative of fitting a shoe box top on a shoebox. Figure seven is a geomtric shaped lens, ends open,bttom closed. The thermometer tray or crate which holds the thermometer can ge slid in the end of the lens cover this is relative of sliding a draw in or out. The shape of the draw would be square or rectangular.

1. I claim my plano-convex thermometer lens cover will magnify, whether the shape is round or geometric.
